(19) United States
(12) Patent Application Publication
(10) Pub. No.: US 2015/0125203 A1
(43) Pub. Date: May 7, 2015

(54) C-SHAPED CLAMPING DEVICE

(71) Applicant: KOREA PNEUMATIC SYSTEM CO., LTD., Seoul (KR)

(72) Inventor: Ho-Young Cho, SEOUL (KR)

(73) Assignee: KOREA PNEUMATIC SYSTEM CO., LTD., Seoul (KR)

(21) Appl. No.: 14/401,736

(22) PCT Filed: Jun. 4, 2013
(86) PCT No.: PCT/KR2013/004941

§ 371 Date: Nov. 17, 2014

(30) Foreign Application Priority Data
Jun. 5, 2012 (KR) 1020120060515

(51) Int. Cl. F16B 2/18; F16B 7/04; F16B 2/10

(52) U.S. Cl. CPC F16B 2/18; F16B 2/10; F16B 7/0493
USPC 403/396

(57) ABSTRACT

Disclosed herein is a C-shaped clamping device. The clamping device includes: a C-shaped clamp (20) having facing parts (22) on opposite ends thereof; a cylindrical member (30) inserted into a C-ring of the clamp; a coupler (40) installed in the clamp and passing through the facing parts of the clamp, thus providing force of grasping the member; and an interference ring (50) interposed between the facing parts of the clamp. The interference ring has an inner diameter equal to an outer diameter of the coupler and is inserted into the coupler. A stopper protruding into the clamp is provided on a portion of an outer circumferential edge of the interference ring. The cylindrical member has a depression formed around an outer circumferential surface of the cylindrical member. The depression receives the stopper of the interference ring therein.

### TECHNICAL FIELD

The present invention generally relates to ‘C’-shaped clamping devices and, more particularly, to a clamping device designed such that a member coupled thereto can be prevented from being undesirably removed.

### BACKGROUND ART

FIG. 1 illustrates a bracket for a suction pad used in a vacuum transfer system. Generally, the bracket 100 is connected to a robotic arm 101 and includes a clamp 102 disposed in a lower portion of the bracket 100 to grasp a pipe 103. A separate suction pad 107 is mounted to an end of the pipe 103 and is brought into contact with a surface of a target to be transferred. The vacuum transfer system includes a vacuum pump for pumping air out of the internal space of the suction pad 107.

In detail, a pipe clamping device includes a ‘C’-shaped clamp 102, a pipe 103 inserted into the clamp 102, and coupling members 105 and 106 installed in such a way that the coupling member 105 passes through facing parts 104 provided on opposite ends of the clamp 102. In the above-mentioned construction, the coupling members 105 and 106 provide force with which the clamp 102 grasps the pipe.

However, if force is repeatedly applied to the pipe 103 during a vacuum transfer process, the grasping force of the clamp 102 is gradually reduced. The pipe 103 may be eventually removed from the clamp 102, thus dropping a target that is being transferred. Special countermeasures for solving the above problem are required.

As an example of the countermeasures, a pipe clamping device configured such that an O-ring functioning as an interference member is eccentrically fitted over the coupling member 105 between the opposite facing parts has been proposed. Contact friction between the O-ring and the surface of the pipe 103 is used to prevent the pipe 103 from being undesirably moved or removed. However, this conventional pipe clamping device has the following problems.

First, the presence of the O-ring makes a process of assembling the pipe 103 with the clamp in a sliding manner more difficult.

Second, the O-ring is easily worn by friction between the O-ring and the pipe 103.

Third, when the pipe 103 is inserted into the clamp 102, the O-ring may be pushed by the pipe and thus displaced from the original position. In this case, desired contact friction effects cannot be obtained.

Fourth, the above-mentioned problems make the clamping device unable effectively absorb shock applied to the pipe 103.

### DISCLOSURE

### Technical Problem

Accordingly, the present invention has been made keeping in mind the above problems occurring in the prior art, and an object of the present invention is to provide a clamping device in which an interference member is provided between opposite facing parts of a ‘C’-shaped clamp such that: the interference member is prevented from be undesirably moved or easily worn; a pipe can smoothly slide when assembled with clamp or disassembled therefrom; and external shock can be effectively absorbed, whereby the clamping device can be functionally and structurally stable and reliable.

### Technical Solution

In order to accomplish the above object, the present invention provides a C-shaped clamping device, including: a C-shaped clamp having facing parts on opposite ends thereof; a cylindrical member inserted into a C-ring of the clamp; a coupler installed in the clamp and passing through the facing parts of the clamp, thus providing force of grasping the member; and an interference ring interposed between the facing parts of the clamp. The interference ring has an inner diameter equal to an outer diameter of the coupler and is inserted into the coupler. A stopper protruding into the clamp is provided on a portion of an outer circumferential edge of the interference ring. The cylindrical member receiving the stopper of the interference ring therein has a depression formed around an outer circumferential surface of the cylindrical member.

The cylindrical member may have a path formed by surface-processing a portion of the cylindrical member from a side of the depression to an end of the cylindrical member. The path may have a planar shape or recess shape and enable the stopper to pass through the cylindrical member when the member is inserted into the clamp.

### Advantageous Effects

A clamping device according to the present invention has the following effects.

First, since an inner diameter of an interference ring is the same as an outer diameter of a coupler, the interference ring can be prevented from being undesirably moved by making contact with a member that is being or has been inserted into a clamp.

Second, the interference ring and the member form a counterpart structure, in detail, including a stopper and a depression. Thereby, the member can be more reliably grasped by the clamp, and kinetic friction therebetween can be minimized. Furthermore, shock applied to the member can be effectively absorbed.

Third, a path is formed on the surface of the member, whereby the assembly and disassembly processes can be facilitated.

### DESCRIPTION OF DRAWINGS

FIG. 1 is a view showing a clamping device according to a conventional technique.

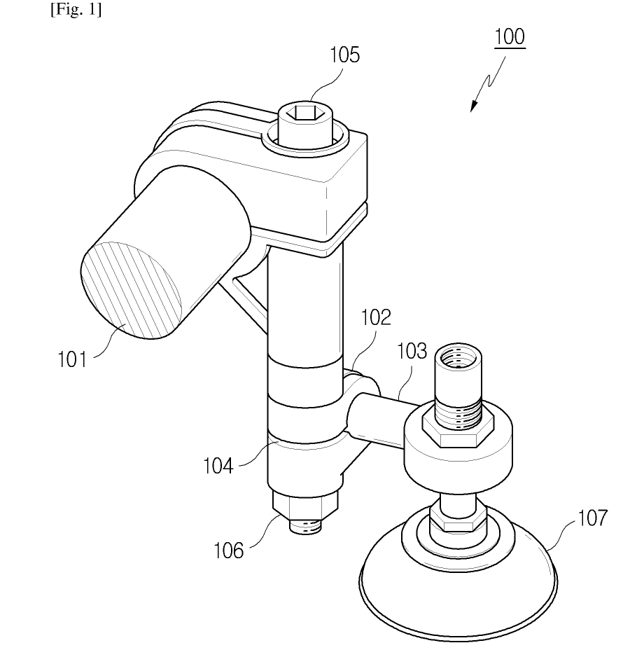

FIG. 2 is a perspective view illustrating a clamping device according to the present invention.

FIG. 3 is an exploded perspective view of the device of FIG. 2.

FIG. 4 is a sectional view illustrating a coupling process of the device of FIG. 2.

FIG. 5 is a sectional view taken along line A-A of FIG. 2.

### BEST MODE

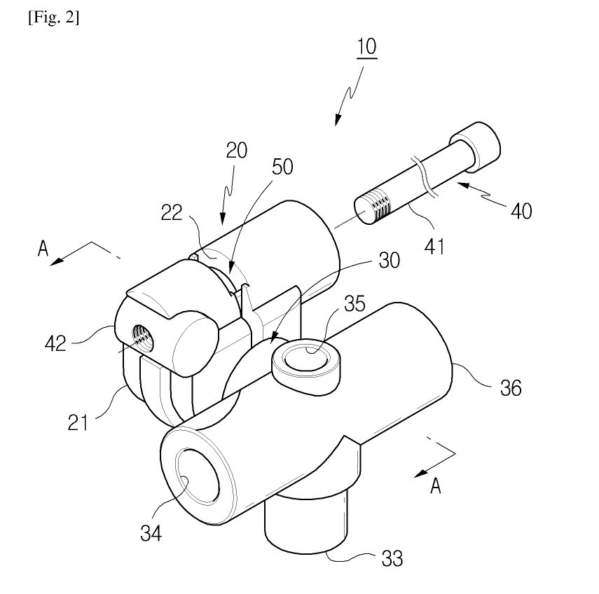

The above and other objects, features and advantages of the present invention will be more clearly understood from the following detailed description taken in conjunction with the accompanying drawings. In FIG. 2 and the following drawings, a pipe clamping device according to the present invention is designated by reference numeral 10.

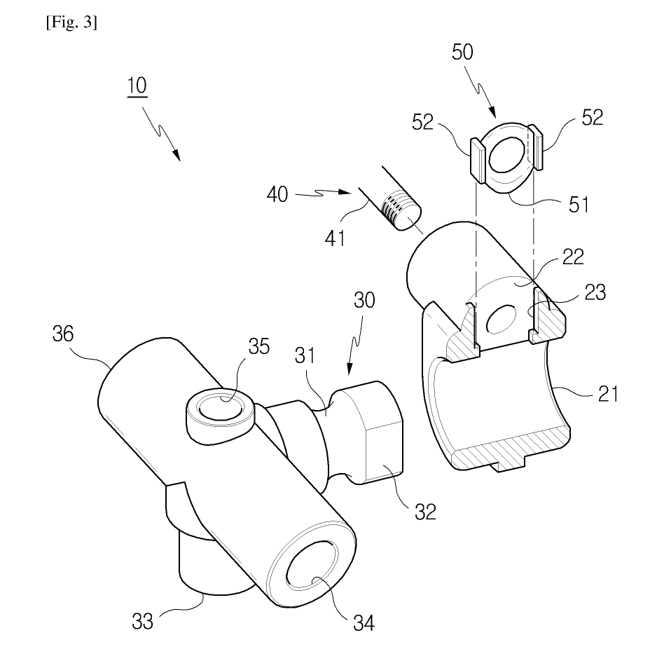

Referring to FIGS. 2 and 3, the clamping device 10 according to the present invention includes: a C-shaped clamp 20 having opposite facing parts 22; a cylindrical member 30 inserted into a C-ring 21 of the clamp 20; a coupler 40 installed in the clamp 20 and passing through the opposite facing part 22 of the clamp 20 so as to provide force of grasping the member; and an interference ring 50 interposed between the opposite facing parts 22.

The clamp 20 is a typical C-shaped clamp, including the C-ring 21 having an almost circular cross-section, and the opposite facing parts 22 provided on respective opposite ends of the C-ring 21.

The cylindrical member 30 is inserted into the C-ring 21 of the clamp 20 and is brought into close contact with an inner surface of the C-ring. The term ‘cylindrical’ must be understood as meaning that the outer circumference of the cross-section thereof is circular. Regardless of the term, the cylindrical member 30 may be hollow or solid. In the embodiment of the drawings, a pipe-shaped member of which an insert end is closed is used as an example of the cylindrical member 30.

A depression 31 is formed around an outer circumferential surface of a part of the cylindrical member 30 that is inserted into the C-ring 21 of the clamp 20. Furthermore, the cylindrical member 30 has a path 32 formed by surface-processing a portion of the cylindrical member 30 from a side of the depression 31 to the end of the cylindrical member 30. In this embodiment, the path 32 is a path processed in a planar form; however, in another embodiment, it may be processed in a recess form.

The depression 31 and the path 32 are parts corresponding to a locking part of the interference ring 50. The relationship between these parts will be explained in more detail later herein.

In the drawings, a ‘T’- or ‘+’-shaped pipe is illustrated as being provided on an end of the cylindrical member 30 that is opposed to the end the cylindrical member 30 that is inserted into the clamp 20. For example, in a vacuum transfer system, openings 33, 34 and 35 of the pipe are respectively used for connection with a suction pad, a vacuum pump for creating a vacuum, and air for breaking the vacuum state. Reference numeral 36 denotes a closed end rather than an opening.

Installed in the clamp 20, the coupler 40 passes through the opposite facing parts 22 and is used as a means for providing the force of grasping the cylindrical member 30 inserted into the C-ring 21. In this embodiment, the coupler 40 includes a bolt 41 passing through the opposite facing part 22, and a nut 42 tightened over an end of the bolt 41.

The interference ring 50 has an inner diameter equal to an outer diameter of the coupler 40 and is fitted over the coupler 40. The interference ring 50 is made of flexible material such as rubber. A stopper 51 protrudes from a portion of an outer circumferential edge of the interference ring 50. When the interference ring 50 is inserted between the opposite facing parts 22 of the clamp 20, the stopper 51 protrudes into the C-ring 21 of the clamp 20 and enters the depression 31 of the cylindrical member 30 inserted into the C-ring 21.

In this embodiment, the interference ring 50 includes at least one guide 52 protruding another portion of the outer circumferential edge of the interference ring 50. A guide depression 23 corresponding to the guide 52 is formed in the opposite facing parts 22 of the clamp 20. These elements 52 and 23 function to prevent the interference ring 50 from undesirably moving or rotating.

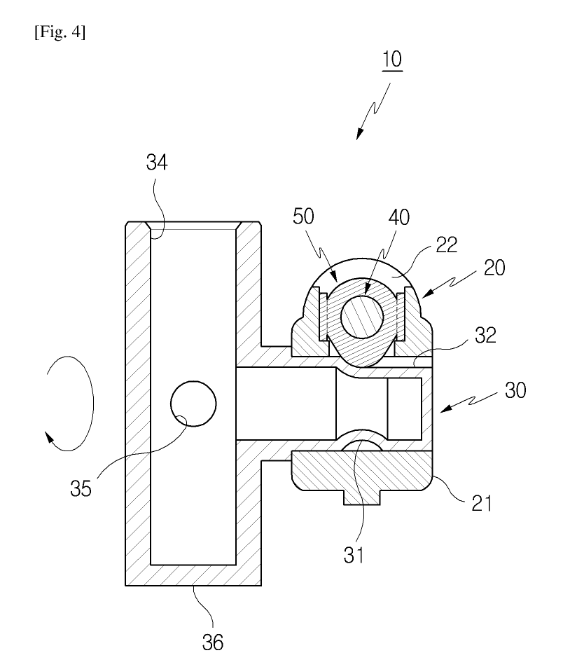

Referring to FIG. 4, the interference ring 50 is interposed between the opposite facing parts 22 of the clamp 20 in such a way that the guide 52 is seated into the guide depression 23 of the opposite facing parts 22. The stopper 51 of the interference ring 50 slightly protrudes into the C-ring 21 of the clamp 20. Subsequently, the cylindrical member 30 is slid and inserted into the C-ring 21.

Here, the path 32 corresponding to the stopper 51 is formed on the cylindrical member 30 from the insert end to the depression 31. Therefore, if the orientation of the path 32 is adjusted such that it corresponds to the stopper 51, the cylindrical member 30 can be comparatively easily moved without paying attention to resistance or friction. FIG. 4 illustrates the cylindrical member inserted into the clamp.

After the cylindrical member 30 has been inserted into the clamp, the cylindrical member 30 is rotated by approximately 90° (refer to the arrow of the drawing).

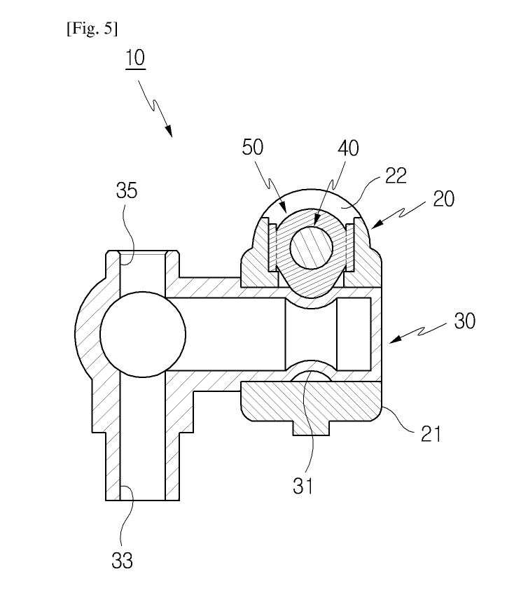

Referring to FIG. 5, the location of the path 32 relative to the stopper 51 is changed by rotating the cylindrical member 30. Thereby, the counterpart relationship between the stopper 51 and the path 32 is removed. Simultaneously, the stopper 51 of the interference ring 50 is completely received in the depression 31 of the cylindrical member 30. Therefore, the coupler 40 is manipulated to bring the opposite facing parts 22 into close contact with each other so as to provide the force of grasping the cylindrical member 30. Then, the cylindrical member 30 is reliably coupled to the clamp 20 by the grasping force.

For example, if a suction pad is coupled to the opening of the cylindrical member 30, shock or force will be repeatedly applied to the cylindrical member 30. However, in the present invention, by virtue of the structure in which the stopper 51 of the interference ring 50 firmly fixed in place without moving is coupled to the depression 31 of the cylindrical member 30, shock or force can be effectively absorbed, whereby the cylindrical member 30 can be prevented from undesirably moving. In this way, the clamping device 10 according to the present invention can reliably ensure functional and structural stability.

1. A C-shaped clamping device, comprising: a C-shaped clamp having facing parts on opposite ends thereof; a cylindrical member inserted into a C-ring of the clamp; a coupler installed in the clamp and passing through the facing parts of the clamp, thus providing force of grasping the member; and an interference ring interposed between the facing parts of the clamp,
wherein the interference ring has an inner diameter equal to an outer diameter of the coupler and is inserted into the coupler, with a stopper provided on a portion of an outer circumferential edge of the interference ring, the stopper protruding into the clamp, and
the cylindrical member has a depression formed around an outer circumferential surface of the cylindrical member, the depression receiving the stopper of the interference ring therein.

2. The C-shaped clamping device of claim 1, wherein the cylindrical member comprises a path formed by surface-processing a portion of the cylindrical member from a side of the depression to an end of the cylindrical member, the path enabling the stopper to pass through the cylindrical member when the member is inserted into the clamp.

3. The C-shaped clamping device of claim 2, wherein the path is formed in a planar shape or a recess shape.

4. The C-shaped clamping device of claim 1, wherein the interference ring comprises at least one guide protruding from another portion of the outer circumferential edge of the interference ring, and
a guide depression is formed in the facing parts of the clamp, the guide depression corresponding to the guide.

5. The C-shaped clamping device of claim 1, wherein the coupler comprises: a bolt passing through the facing part; and
a nut coupled to an end of the bolt.

6. The C-shaped clamping device of claim 1, wherein a ‘T’- or ‘+’-shaped pipe is provided on an end of the cylindrical member that is opposed to a side of the cylindrical member which is inserted into the clamp.
